(19) United States
(12) Patent Application Publication
(10) Pub. No.: US 2005/0019513 A1
(43) Pub. Date: Jan. 27, 2005

(54) Glass capillary tubes for microinjection, and method for manufacturing a microinjection glass capillary tube

(75) Inventors: Alexander Papra, Hamburg (DE); Norbert Rottman, Hamburg (DE)

Correspondence Address: RANKIN, HILL, PORTER & CLARK LLP, 4080 ERIE STREET, WILLOUGHBY, OH, 44094-7836, US

(73) Assignee: EPPENDORF AG, Hamburg (DE)

(21) Appl. No.: 10/889,705

(22) Filed: Jul. 13, 2004

(30) Foreign Application Priority Data
Jul. 26, 2003 (DE) 10334164.1-41

(51) Int. Cl. B32B 1/08

(52) U.S. Cl. 428/34.4

(57) ABSTRACT

A microinjection glass capillary fitted with a biomolecule-repellant polymer coating at its tip is characterized in that the inside diameter of the glass capillary is less than 10 μ in the tip zone.

### BACKGROUND OF THE INVENTION

The present invention relates to a microinjection glass capillary tube, hereafter glass capillary, used in microinjection and having, at its tip, a polymer coating exhibiting repellence toward biomolecules.

Such glass capillaries are used in various bio- and health-fields, for instance when injecting mRNA or amphibian oocytes, or substances into cells or cell nuclei to prepare transgenic cells, or for intracytoplasmic sperm injection (ICSI). Injected substances may be biomolecules (namely nucleotides, amino acids, nucleic acids, proteins, hormones, second messengers), cell organelles or cells (for instance sperm cells).

As a rule microinjection glass capillaries exhibit very fine tips to easily penetrate the cells, to minimize injuring them and moreover to allow injecting small volumes.

Because of the small tip diameter, the substance to be injected may easily accumulate at the tip's inside wall. Charged substances in particular, for instance nucleic acids or proteins, tend to accumulate because glass capillary surfaces also frequently are charged. Such accumulations are a particular danger when carrying out long series of tests with repeated injections. Said accumulations may reduce the effective tip diameters and as a result, illustratively in the course of one set of tests, the injection volume may change. On the other hand many applications require rigorous reproducibility of the injected volume.

As a worst case, the accumulated substances to be injected may entirely clog the tip and then a new glass capillary must be used. In this case again accurate reproducibility of injected volume no longer is assured.

Furthermore such substances as biomolecules, cell organelles or cells, may accumulate on the glass capillary outer side and degrade thereby the tip diameter and hence the injected volume. Such accumulations also may degrade the capillary's cell penetration.

It is widely known in the state of the art to reduce the accumulation of various substances at glass surfaces by silanizing the latter. Frequently and illustratively hexamethyidisilazane (HMDS) is used in life science labs to silanize microinjection glass capillaries by evaporating it onto the already drawn out capillaries, thereby also being suitable for capillaries of very small tip diameters. However such treatment only insufficiently reduces clogging of the capillaries or the external accumulation. Also the treatment carried out in the particular labs, which is individual, is only poorly reproducible and therefore entails different results precluding comparison between them.

It is also known to coat glass capillaries used in microinjecting proteins into Xenopus oocytes with the positively charged substance polyethylene imine (PEI) to preclude clogging the capillaries and thereby to extend their service life (C L Lee (1999): Localized measurement of kinase activation in oocytes in Xenopus laevis, Nature Biotech 17, pp 759-762). However PEI coating is applicable only to glass capillaries exhibiting a relatively large inside tip diameter because PEI forms a three-dimensional (3D) polymer structure during such coating. In said document, the tip diameter of the P.E.I.-coated capillaries is about 50 μ. Such capillaries are suitable only for microinjecting very large cells such as Xenopus oocytes that exhibit a diameter of about 1,000 μ. Said capillaries however are unsuitable for injections into mammalian oocytes (about 150 μ), somatic cells (about 50 μ) cell nuclei (about 10 μ) or cell organelles (<10 μ). Because of its positive charge, said described coating only precludes the accumulation of those biomolecules carrying a net positive charge. This kind of coating does not prevent the accumulation of nucleic acids and negatively charged proteins.

### SUMMARY OF THE INVENTION

The objective of the present invention is to create a glass capillary exhibiting biomolecule-repellant properties and also being appropriate for further applications in cell biology. Another objective of the present invention is to create a method for manufacturing such a glass capillary.

### DETAILED DESCRIPTION OF THE PREFERRED EMBODIMENTS

The first objective of the present invention is solved by a glass capillary fitted with a biomolecule-repellant coating of which the inside diameter is less than 10 μ in the tip zone. Such a capillary also is appropriate for repeated and reproducible injections of various substances into such objects as for instance mammal oocytes.

In one preferred implementation of the present invention, the inside diameter of its glass capillary is less than 5 μ, preferably less than 2 μ, in the tip zone. Such a capillary is appropriate for repeated and reproducible injection of different substances, especially into small objects such as somatic cells, cell nuclei and cell organelles.

In another preferred implementation of the present invention, the biomolecule-repellant coating comprises an ingredient in the form of a polyethylene glycol. Contrary to the case of many other organic polymers such as PEI, polyethylene glycol is uncharged and therefore is an appropriate means to prevent biomolecules of any charge from accumulating, illustratively including nucleic acids and negatively charged proteins. Moreover bound polyethylene glycol is bio-compatible and will not degrade the physiology of the target objects.

The use of surface-bound polyethylene glycol to preclude non-specific binding of proteins and other biomolecules is known in the state of the art (Harris, J M [1992], Poly (Ethylene Glycol) Chemistry, Plenum Press, New York 1992).

Moreover U.S. Pat. No. 6,235,340 discloses how to fit surfaces—for instance of glass pipets or glass syringes—with biomolecule-repellant coatings. The coatings discussed in this document illustratively are oligoethylene glycol molecules.

However the application of a coating containing polyethylene glycol in microinjection glass capillaries is not known. Heretofore such an application could not be carried out because depositing a polymer coating in a microinjection glass capillary entails considerable difficulties on account of the extant restricted space in the capillary tip zone. In particular there is danger that a 3D polymer structure shall form when the coating agent is being deposited, said structure possibly resulting in clogging the tip aperture. Also treating the capillary with corrosive agents, for instance when cleaning and/or pretreating the glass surface prior to coating, may destroy the very fine structure of the capillary tip whereby the capillary would become unsuitable for microinjection.

Applicant is the first to succeed in creating a microinjection glass capillary that is fitted with a biomolecule-repellant coating of which one ingredient is polyethylene glycol.

In an especially preferred implementation of the invention, the biomolecule-repellant coating contains an ingredient in the form of a polyethyleneglycol silane. Molecules of this class are polar, the organic polyethylene glycol ingredient pointing one direction and the inorganic silane ingredient pointing in the other, and, in addition, such molecules exhibit the biomolecule-repellant properties for which polyethylene glycol is known. They may be bound by means their silane group to glass surfaces while forming a covalent bond and as a result uniform orientation of the bound molecules at the glass surface is assured. The polyethylene glycol groups always point away from the glass surface and thereby they impart biomolecule-repellant properties to the substrate. In addition, when selecting appropriate conditions, polyethylene glycol silanes form a mono-layer on the glass surface and will not polymerize with one another, and thus the thickness of the deposited coating may be determined by the chain length of the polymer used.

2-[methoxy(polyethyleneoxy)propyl]-trimethoxysilane was found to be an especially advantageous polyethylene glycol silane. This compound allows depositing biomolecule-repellant biomolecules of a thickness no more than 2 nm on the glass capillaries. Such coatings are appropriate for capillaries having tip diameters in sub-micron range such as are used for instance for microinjections into mammalian oocytes, cells, cell nuclei and cell organelles.

In a further preferred implementation of the invention, the biomolecules-repellant coating contains a ingredient in the form of a fluoroalkyl. Contrary to the case of polyethylene glycols, fluoroalkyls exhibit no biomolecule-repellant properties, instead being ultra-hydrophobic. Accordingly fluoroalkyl-coated surfaces are practically unwettable. This effect is known illustratively as regards objects (dishes, textiles) that are coated with the polytetrafluoroethylene (Teflon) fluoroalkyl. Because of the ultrahydrophobic properties of a fluoroalkyl-coated glass surface, biomolecules present in the aqueous phase cannot come into contact with the surface where otherwise they would deposit.

Applicant has succeeded in creating for the first time a microinjection glass capillary which is fitted with a biomolecule-repellant coating containing a fluoroalkyl.

Heretofore such coatings could not be prepared because of the considerable difficulties—due to the extant restricted space—of depositing a fluoroalkyl coating in a microinjection glass capillary. In such a case the preconditions are similar to those relating to polymer coating, for instance the very fine structure of the capillary tip might be destroyed and said capillary be made unsuitable for microinjection when before such coating the glass surface is treated with corrosive agents, for instance for purposes of cleaning and/or pre-treatment.

In an especially preferred implementation of the invention, the biomolecule-repellant coating contains an ingredient in the form of a fluoroalkyl silane. Molecules of this kind are polar, the organic fluoroalkyl ingredient pointing in one direction and the inorganic silane ingredient in the other direction, and said molecules moreover exhibit the known ultrahydrophobic properties of the fluoroalkyls. They may be bound by means of their silane group to glass surfaces while forming a covalent bond, thus assuring uniform orientation of the bound molecule at the glass surface. The fluoroalkyl groups always point away from the glass surface and in this manner act hydrophobically. When appropriate conditions are selected, the fluoroalkyl silanes constitute a monolayer on the glass surface, as a result of which the thickness of the deposited coating may be determined by the chain length of the fluoroalkyl being used.

[Heptadecafluoro-1,1,2,2-tetrahydrodecyl]-triethoxy silane was found to be an especially advantageous fluoroalkyl silane on account of its high hydrophobicity, its molecule size and its bonding properties to glass surfaces.

In one advantageous implementation of the invention, the coating is configured on the inside of the capillary. In this manner accumulation of the substance to be injected on the capillary inside surface is precluded and reduction or clogging of the capillary tip is averted.

In another advantageous implementation of the invention, the coating is configured both on the inside surface and on the outside surface of the capillary. In this manner accumulation of biomolecules, cell organelles, cells or contaminations at the glass capillary outer side is averted also and as a result degradation of the capillary tip or of the ability of the capillary to penetrate the cell shall be precluded.

The second objective of the present invention is solved by a method in which the capillary is dipped into a coating solution and as a result said solution enters the capillary; after this solution has incubated in the capillary, it will be removed by suction and subsequent application of a pressurized gas.

In a further advantageous implementation of said method, after the said coating solution has been removed, the capillary shall be rinsed with a washing solution and then dried while a pressurized gas is made to flow through it. Removal by blowing out the coating solution and any washing solution is mandatory to prevent the tip from clogging. This requirement also applies to the case of the washing solution being distilled water. Illustratively the blowing gas may be purified compressed air, though it may also be an inert gas such as helium or any other suitable gas.

In a further advantageous implementation of said method, the capillary shall be heat-treated after a pressurized gas was made to pass through it.

In one advantageous embodiment of said method, the coating solution contains polyethylene glycol. Polyethylene glycol silane is especially preferred.

It is already known in the state of the art (A Papra et al, 2001, Characterization of Ultrathin Poly(ethyleneglycol) Monolayers on Silicon Substrates; Langmuir 17, 1457) to use such substances when coating planar silicate substrates to prevent non-specific protein adhesion. First a silicon chip is pre-treated with a mixture of 30% hydrogen peroxide and concentrated sulfuric acid (Caro's acid) and then is incubated with a strongly acid coating solution (<pH 2 adjusted with hydrochloric acid) containing polyethylene glycol silane and toluene. Following incubation the chip is washed and purified by sonification.

In this method, Caro's acid is used to oxidize and purify the silicon substrate whereas toluene in the coating solution is used on one hand as a solubilizer and on the other hand to enhance covalent bonds formation between the silicon substrate and the polyethylene glycol silane.

Such a procedure intended to coat planar surfaces cannot be applied on a number of grounds to coating glass capillaries. Using corrosive substances such as Caro's acid or toluene is precluded because they would destroy the very fine structure of the capillary tip, the capillary thereby becoming unsuitable for microinjections. Highly acidic pH values again destabilize the capillary tip. Sonification as well would render the capillary unsuitable because the high-frequency vibrations would destroy the capillary tip. Moreover organic solvents such as toluene are toxic and hence are inappropriate in treating microinjection capillaries that would be used for instance for intracytoplasmic sperm injection (ICSI) or other applications in the biological or health sciences.

Experiments run by applicant show that microinjection glass capillaries may be coated very well and simply by means of the features of claim 11 using polyethylene glycol silanes. It was discovered that toluene and other organic solvents may be omitted from the coating solution by replacing them with water as the solvent, provided the concentration of the polyethylene glycol silane be low. A concentration of roughly 2% was found advantageous. At such concentrations the pH value of the coating solution also may be adjusted to be less strongly acidic. Experiments run by applicant show that a pH value of 4 adjusted using acetic acid is appropriate.

Said experiments surprisingly show that within the scope of the method of the present invention, the glass surfaces need not be cleaned because the glass capillaries to be coated are manufactured at an electrode drawing device directly before coating and following manufacture are vacuum packed and will be removed from the wrap only immediately before being coated. On account of the melting processes taking place during manufacture, the capillaries always form a new inner and outer surface of absolute cleanliness therefore requiring no cleaning. Contrary to the case of the above described procedure for coating silicon chips, the present invention does not require pretreating the glass surfaced with Caro's acid.

Further it was discovered in the course of the present invention that the coated capillaries already can be cleaned gently and effectively by washing and then passing a compressed gas through them instead of subjecting them, as known from the above cited document, to sonification.

By refraining from using toluene and Caro's acid, by resort to the gentle pH value and again refraining from sonification, the sensitive capillary tip is shielded from undue stresses and as a result it is now feasible to coat them with polyethylene glycol. At the same time the bio-compatibility of the coated capillaries is improved by refraining from using organic solvents such as toluene.

By selecting appropriate conditions, the method of the present invention assures that the bound molecules shall constitute a monolayer and that 3D polymerization and ensuing clogging of the capillary tip shall be precluded. By deliberately selecting molecules of defined chain lengths, it is furthermore feasible to control the deposited coating thickness.

In an especially preferred implementation of the present invention, the polyethylene glycol silane used is 2-[methoxy(polyethyleneoxy(propyl]trimethoxy silane. Applicant's tests show that said method and said compound allow depositing biomolecule-repellant coatings having a thickness maximally of 2 nm on glass surfaces. Because of their thinness, the coatings are consequently appropriate for glass capillaries having tip diameters in the sub-micron range such as are needed for microinjection into somatic cells, cell nuclei and cell organelles.

In a further preferred implementation of the method of the invention, the coating solution does contain a fluoroalkyl. In especially preferred manner, a fluoroalkyl silane is used which on one hand, while forming a silane compound, can be connected to the surface of the microinjection capillary and which on the other hand on account of the extreme hydrophobicity of the capillary imparts a biomolecule-repellant property. Contrary to the case of the above method wherein the coating solution contains a polyethylene glycol silane, this method requires an organic solvent such as ethanol to solubilize the fluoroalkyl silane. However ethanol only exhibits relatively low toxicity and especially will not harm fruits, and it may be removed entirely by being flushed with water, as a consequence of which the use of ethanol in the coating solution does not impair either the use of the coated capillary in toxically critical applications.

Aromatic hydrocarbons such as toluene, corrosive substances such as Caro's acid, extreme pH values or sonification however are not used either in the above method. Accordingly the susceptible capillary tips will be widely preserved from damage during the coating stage.

An especially effective and hence preferred coating substance was found to be [heptadecafluoro-1,1,2,2-tetrahydrodecyl]-triethoxysilane.

Two Examples of the deposition of a molecule-repellant coating on a microinjection capillary using the method of the invention are elucidated below.

### EXAMPLE 1

### Method for Coating Microinjection Capillaries with Polyethylene Glycol

1. A sterile glass microinjection capillary (Eppendorf Femtotip having an inside diameter of 0.5 μ) is removed from its wrapping and is incubated with the coating solution (1% by vol. methoxy-(polyethyleneoxy)-propyltrimethoxy silane in ddH₂O, pH=4 adjusted using acetic acid) for 30 min at room temperature. Because of capillary forces, the coating solution reaches the capillary tip.
2. The coating solution is removed by being evacuated with the suction medium (ddH₂O). Thereupon purified air is made to pass through the capillary until latter is also externally dry.
3. The capillary is incubated with washing solution (ddH₂O) and compressed air is blown through it until external dryness also has been attained. This procedure is repeated once.
4. The capillary is baked at about 70° C. for 1 h.
5. The capillary is moved into a clean wrapping and stored therein until being used.

### EXAMPLE 2

### Method for Coating Microinjection Capillaries with Fluoroalkyl Silanes

1. A sterile glass microinjection capillary (Eppendorf Femtotip, inside diameter=0.5 μ) is removed from its wrapping and is incubated with the coating solution [heptadecafluoro-1,1,2,2-tetrahydrodecyltriethoxysilane in ethanol) for 30 min. at room temperature. The protective cap is left in place and the solution is introduced by means of hydrostatic pressure into the pipet tip.
2. The coating solution is evacuated by suction with suction medium. Thereupon purified compressed air is made to pass through the capillary until said capillary is also externally dry.
3. The capillary is incubated with washing solution (ethanol) and compressed air is blown through it until external dryness is also attained. This procedure is repeated once.
4. The capillary is baked at about 70° C. for 1 h.
5. The capillary is moved into a clean wrapping and stored until being used.

1. A glass capillary tube, hereafter glass capillary, used in microinjection, comprising at its tip a polymer coating exhibiting repellence toward biomolecules, characterized in that the inside diameter of the glass capillary is less than 10 μ (microns).

2. Glass capillary as claimed in claim 1, characterized in that its inside diameter in its tip zone is less than 5 μ.

3. Glass capillary as claimed in either of claims 1 and 2, characterized in that the biomolecule-repellant coating contains an ingredient in the form of polyethylene glycol.

4. Glass capillary as claimed in either of claims 1 and 2, characterized in that the biomolecule-repellant coating comprises an ingredient in the form of a polyethylene glycol silane.

5. Glass capillary as claimed in claim 4, characterized in that the biomolecule-repellant coating comprises a component in the form of 2-[methoxy(polyethyleneoxy)propyl]-trimethoxysilane.

6. Glass capillary as claimed in either of claims 1 and 2, characterized in that the biomolecule-repellant coating comprises an ingredient in the form of a fluoroalkyl.

7. Glass capillary as claimed in either of claims 1 and 2, characterized in that the biomolecule-repellant coating comprises an ingredient in the form of a fluoroalkyl silane.

8. Glass capillary as claimed in claim 7, characterized in that the biomolecule-repellant coating comprises an ingredient in the form of [heptadecafluoro-1,1,2,2-tetrahydrodecyl]-triethoxysilane.

9. Glass capillary as claimed in one of the above claims, characterized in that the coating is configured at the inner side of the capillary.

10. Glass capillary as claimed in one of the above claims, characterized in that the coating is configured both at the inner side and on the outer side of the capillary.

11. A method for manufacturing a glass capillary fitted with a biomolecule-repellant coating, wherein
(a) The capillary is dipped into a coating solution in a manner that
(b) The coating solution penetrates the capillary,
(c) following incubation in the capillary, the coating solution is removed by suction and then a pressurized gas is made to pass through this capillary.

12. Method for manufacturing a glass capillary comprising a biomolecule-repellant coating as claimed in claim 11, characterized in that
after the removal of the coating solution, the capillary is washed with a washing solution and then is dried by passing a pressurized gas through it.

13. Method for manufacturing a glass capillary fitted with a biomolecule-repellant coating as claimed in either of claims 11 and 12, characterized in that after a gas has been made to pass through the capillary, this capillary is heat treated.

14. Method for manufacturing a glass capillary fitted with a biomolecule-repellant coating as claimed in claim 11, 12 or 13, characterized in that the coating solution contains a polyethylene glycol.

15. Method for manufacturing a glass capillary fitted with a biomolecule-repellant coating as claimed in claim 11, 12 or 13, characterized in that the coating solution contains a polyethylene glycol silane.

16. Method for manufacturing a glass capillary fitted with a biomolecule-repellant coating as claimed in claim 14, characterized in that the coating solution contains 2-[methoxy(polyethyleneoxy)propyl]-trimethoxysilane.

17. Method for manufacturing a glass capillary fitted with a biomolecule repellant coating as claimed in claim 11, 12 or 13, characterized in that the coating solution contains a fluoroalkyl.
